(19) United States
(12) Patent Application Publication
(10) Pub. No.: US 2011/0110710 A1
(43) Pub. Date: May 12, 2011

(54) BALL JOINT

(75) Inventors: ZHI-MING ZHAO, Shenzhen City (CN); GUO-QING ZHANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/650,885

(22) Filed: Dec. 31, 2009

(30) Foreign Application Priority Data
Nov. 11, 2009 (CN) 200910309558.7

(51) Int. Cl. F16C 11/06

(52) U.S. Cl. 403/135

(57) ABSTRACT

A ball joint includes a ball head and a ball socket. The ball head has a spherical head and a rotatable post extending from the spherical head. The ball socket defines a receiving cavity for rotatably receiving the spherical head. The ball socket forms a plurality of annular resisting surfaces on an inner surface defining the receiving cavity. Each annular resisting surface is tangent with an outer surface of the spherical head.

### BACKGROUND

1. Technical Field

The present disclosure relates generally to a ball joint and, more particularly, to a ball joint used in a manipulator in robotics.

2. Description of Related Art

Ball joints are widely used in industrial machining, such as in a manipulator. A ball joint generally has a ball socket and a ball head rotatably received therein. The ball head has an outer surface corresponding to an inner surface of the ball socket, allowing for smooth movement therein. However, the ball joint is frequently manufactured by extrusion molding, and the inner surface of the ball socket being spherical can be easily malformed during manufacture. As a result, the ball socket may not precisely fit the ball head.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an embodiment of a ball joint.

FIG. 2 is a cross-section of the ball joint of FIG. 1, taken along line II-II.

FIG. 3 is an exploded, isometric view of the ball joint of FIG. 1.

### DETAILED DESCRIPTION

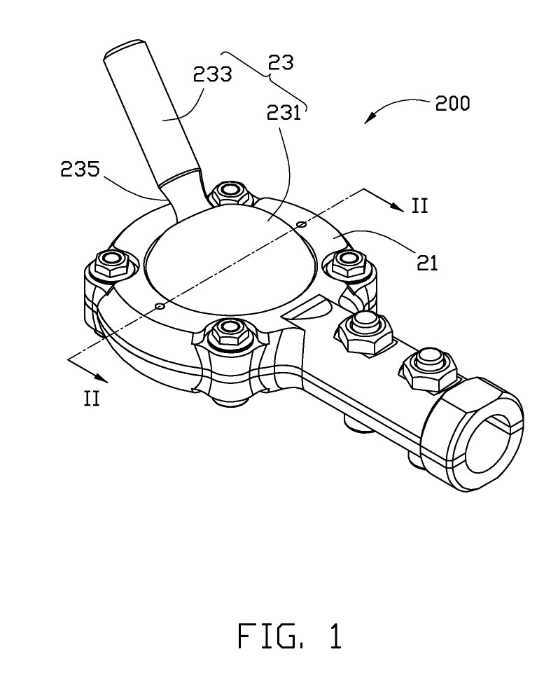

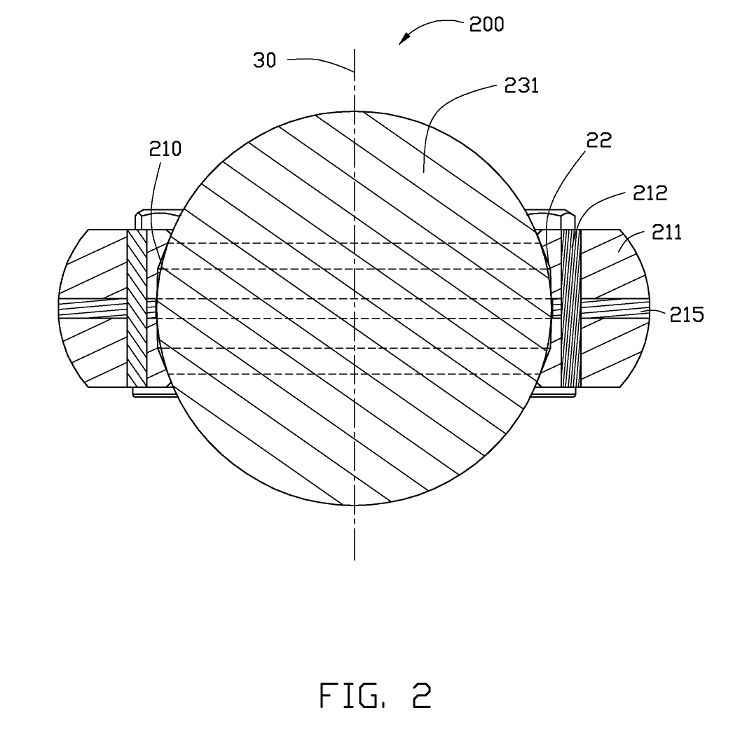

Referring to FIGS. 1 and 2, an embodiment of a ball joint 200 includes a ball socket 21 and a ball head 23 rotatably received in the ball socket 21.

The ball head 23 includes a spherical head 231 and a rotatable post 233 extending from the spherical head 231.

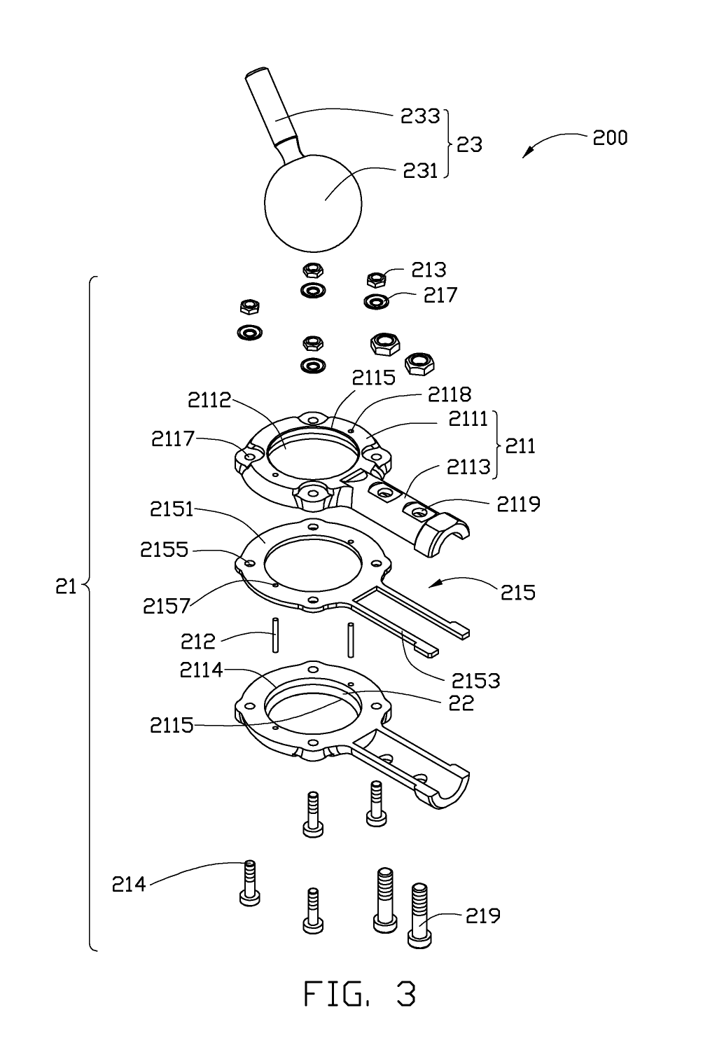

Referring to FIG. 3, the ball socket 21 includes two socket covers 211, two positioning pins 212, a plurality of nuts 213, a plurality of first fasteners 214, a washer 215, a plurality of spring washers 217, and a plurality of second fasteners 219. In the illustrated embodiment, the ball socket 21 includes four first fasteners 214, two second fasteners 219 and four spring washers 217. Both the first fastener 214 and the second fasteners 219 can be screws.

Each socket cover 211 includes an annular main body 2111 and a handle portion 2113 extending from an edge of the main body 2111. The main body 2111 defines a receiving portion 2112 having a first end 2114 and a second end 2115. A diameter of the first end 2114 is equal to the diameter of the spherical head 231, and a diameter of the second end 2115 is less than the diameter of the spherical head 231. Two flat annular resisting surfaces 22 are formed on the inner surface of the main body 2111, and the annular resisting surfaces 22 are joined with each other to form an obtuse angle. The main body 2111 also defines four fixing holes 2117 uniformly arranged at an edge of the main body 2111, and two pin holes 2118 corresponding to the positioning pins 212. The handle portion 2113 defines two assembly holes 2119 corresponding to the second fasteners 219.

The washer 215 includes an annular main portion 2151 and two parallel legs 2153 extending from an edge of the main portion 2151. The main portion 2151 defines four positioning holes 2155 corresponding to the fixing holes 2117 of the socket cover 211, and two through holes 2157 corresponding to the pin holes 2118 of the socket cover 211. An inner diameter of the main portion 2151 is equal to the diameter of the first end 2114. In the illustrated embodiment, the washer 215 is made of plastic.

During assembly of the ball joint 200, the spherical head 231 is positioned into the receiving portion 2112 of one socket cover 211 from the first end 2114. The washer 215 is disposed on the first end 2114 of the socket cover 211, and then the other socket cover 211 is disposed on the washer 215. The two socket covers 211 align with each other to form a receiving cavity 210 for receiving the spherical head 231. Since the diameter of the second end 2115 of the receiving portion 2112 is less than the diameter of the spherical head 231, the second end 2115 prevents the spherical head 231 from withdrawing from the ball socket 21. The rotatable post 233 extends beyond the socket cover 211 from the second end 2115 at the receiving portion 2112. The handle portions 2113 of the socket covers 211 cooperatively form a hollow cylindrical connecting portion (not labeled). The positioning pins 212 extend through the pin holes 2118 of the socket covers 211 and the through holes 2157 of the washer 215. The second fasteners 219 extend through the assembly holes 2119 of the handle portion 2113; and the second fasteners 219 engage the nuts 213. The first fasteners 214 extend through the fixing holes 2117 of one socket cover 211, the positioning holes 2155 of the washer 215, the fixing holes 2117 of the other socket cover 211, and the spring washers 217, respectively; and then the first fasteners 214 engage the nuts 217. Thus, the socket covers 211 and the washer 215 are fixed together with the washer 215 sandwiched between the washer 215.

Referring to FIGS. 2 and 3, after the ball joint 200 is assembled, the spherical head 231 is received in the receiving cavity 210 of the ball socket 21. An inner surface (not labeled) defining the receiving cavity 210 has four annular resisting surfaces 22 tangent with an outer surface of the spherical head 231. That is, the receiving cavity 210 has four truncated cone-shaped cavities (not labeled), aligning along the center axis 30 of the ball socket 21. The resisting surfaces 22 are the side surfaces defining the truncated cone-shaped cavities.

In use, the rotatable post 233 and the handle portion 2113 are connected to different parts of a manipulator. Since the ball socket 21 has four annular resisting surfaces 22 tangent with the outer surface of the spherical head 231, the spherical head 231 is capable of smoothly rotating in the receiving cavity 210 of the ball socket 21. In alternative embodiments, the ball socket 21 may define one or more resisting surfaces 22 having different angles formed between two adjacent resisting surfaces. Increased number of the annular resisting surfaces 22 formed at the ball socket 21 enhances the smoothness of the spherical head 231 during rotation. The resisting surfaces 22 are cylindrical and thus easily machined by a milling cutter.

In addition, the ball socket 21 is detachable, whereby when one of the socket covers 211 and the washer 215 is broken, only the broken one needs to be replaced. Furthermore, the ball socket 21, if not formed by extrusion molding, can be made thinner and lighter.

It should be pointed out that the rotatable post 233 can define an annular groove 235 (as shown in FIG. 1) at an end adjacent to the spherical head 231, in order to increase a rotation angle of the rotatable post 233. Furthermore, the socket covers 211 may be of different shapes. For example, a depth of the receiving portion 2112 of one socket cover 211 can exceed the depth of the receiving portion 2112 of the other socket cover 211.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A ball joint, comprising:
a ball head comprising a spherical head and a rotatable post extending from the spherical head; and
a ball socket defining a receiving cavity for rotatably receiving the spherical head,
wherein the ball socket forms at least one annular resisting surface on an inner surface defining the receiving cavity, and each of the at least one annular resisting surfaces is tangent with an outer surface of the spherical head.

2. The ball joint of claim 1, wherein the ball socket comprises two socket covers, each socket cover comprising a main body comprising a receiving portion, and the receiving portions of the socket covers cooperatively forming a receiving cavity.

3. The ball joint of claim 2, wherein each receiving portion comprises a first end and a second end; a diameter of the first end equaling the diameter of the spherical head, and a diameter of the second end is less than the diameter of the spherical head.

4. The ball joint of claim 2, wherein each socket cover further comprises a handle portion extending from an edge of the main body.

5. The ball joint of claim 2, wherein the ball socket further comprises a washer sandwiched between the two socket covers.

6. The ball joint of claim 5, wherein the washer comprises an annular main portion and two parallel legs extending from an edge of the main portion.

7. The ball joint of claim 5, wherein the ball socket further comprises a plurality of fasteners and a plurality of nuts; the fasteners extending through the socket covers and the washer, and the fasteners engaging the nuts.

8. The ball joint of claim 7, wherein the ball socket further comprises a plurality of spring washers sleeved on the fasteners.

9. The ball joint of claim 5, wherein the ball socket further comprises two positioning pins extending in the socket covers and the washer.

10. The ball joint of claim 2, wherein the number of annular resisting surfaces is four, and each socket cover respectively forming two annular resisting surfaces.

11. The ball joint of claim 10, wherein two annular resisting surfaces of each socket cover joined together to form an obtuse angle.

12. The ball joint of claim 1, wherein the rotatable post defines an annular groove at an end adjacent to the spherical head.
